(19) United States
(12) Patent Application Publication
(10) Pub. No.: US 2016/0084739 A1
(43) Pub. Date: Mar. 24, 2016

(54) DEVICE AND METHOD FOR INSPECTION OF TIRE

(71) Applicant: HYUNDAI MOTOR COMPANY, Seoul (KR)

(72) Inventor: Joon Seo PARK, Yongin-si (KR)

(73) Assignee: HYUNDAI MOTOR COMPANY

(21) Appl. No.: 14/546,872

(22) Filed: Nov. 18, 2014

(30) Foreign Application Priority Data
Sep. 22, 2014 (KR) 10-2014-0126191

(51) Int. Cl. G01M 17/02

(52) U.S. Cl. CPC G01M 17/027

(57) ABSTRACT

A tire inspection device is disclosed. The disclosed tire inspection device for inspecting at least one tire being transferred from a tire sub-line to a tire mounting process along a transfer conveyor, may include i) a frame mounted to an outside of the transfer conveyor, ii) a first camera fixedly secured to the frame over the transfer conveyor configured to capture data from a surface of the at least one tire placed on the transfer conveyor, and iii) a controller configured to analyze the data captured by the first camera, detect a position of a balance marker on the surface of the at least one tire, and determine an orientation of the at least one tire based on the detected position of the balance marker.

### CROSS-REFERENCE TO RELATED APPLICATION

This application claims priority to and the benefit of Korean Patent Application No. 10-2014-0126191 filed in the Korean Intellectual Property Office on Sep. 22, 2014, the entire contents of which are incorporated herein by reference.

### TECHNICAL FIELD

An exemplary embodiment of the present inventive concept relates to a device for inspection of a tire. More particularly, the present disclosure relates to a device and method for inspection of a tire, which can inspect the orientation and specification of a tire on a tire sub-line which transfers the tire to a tire mounting process.

### BACKGROUND

In general, in order to manufacture a vehicle, different process lines are required, starting from selection of materials to mass production of products. The process lines produce many products within a short time period via automated factory systems.

In a tire mounting process in an outfitting process line, a tire is transferred along a transfer conveyor from a tire sub-line to a tire mounting position of a vehicle body with a tire loading unit. A worker then mounts the tire to the vehicle body.

In this case, at the tire sub-line, tire storage spaces are designated for different specifications of vehicles, and 4-5 stacked tires are supplied to each of the designated storage spaces. The tires stored in the storage spaces corresponding to different vehicle specifications are then transferred to the tire mounting process with the transfer conveyor.

However, in a process for supplying the tires to the designated tire storage spaces, a worker verifies the specification of the tire visually. It is liable that a tire of wrong specification may be introduced to the designated tire storage space by mistake of the worker.

Moreover, there has recently been an increase in the use of asymmetric tires, where the inside tread pattern of the tire is different from the tread pattern on the outside of the tire. In those cases, it is critical that the tire be placed in the storage space in a specific orientation. The worker is liable to supply the tire in an incorrect orientation due to human error.

Consequently, in related art, if a tire of wrong specification is introduced to the designated tire storage space and supplies the tire to the designated storage space in an incorrect orientation, assembly of a wheel and the tire with mismatched specifications and wrong assembly is liable to take place in the tire mounting process that follows.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide device and method for inspection of a tire having advantages of enabling to inspect the orientation and specification of a tire.

An object of exemplary embodiments of the present inventive concept is to provide a device and method for inspection of a tire, which recognizes a balance marker attached to a surface of a tire and/or a tread portion colored line on the tire, for automated inspection of the orientation and specification of the tire being supplied to a tire mounting process. In an exemplary embodiment of the present inventive concept, a tire inspection device for inspecting at least one tire being transferred from a tire sub-line to a tire mounting process along a transfer conveyor, may include i) a frame mounted to an outside of the transfer conveyor, ii) a first camera fixedly secured to the frame over the transfer conveyor configured to capture data from a surface of the tire placed on the transfer conveyor, and iii) a controller configured to analyze the data captured by the first camera, detect a position of a balance marker on the surface of the tire, and determine an orientation of the tire based on the detected position of the balance marker.

Furthermore, in the tire inspection device in accordance with an exemplary embodiment of the present inventive concept, the controller is further configured to determine that the tire is in a correct orientation if, upon processing the data obtained from the first camera, the balance marker is recognized. The tire inspection device in accordance with an exemplary embodiment of the present inventive concept may further include a second camera mounted to the frame on an outside of the transfer conveyor to be movable in a vertical direction for capturing data a tread portion color line.

In certain embodiments of the tire inspection device, the controller may be configured to analyze the data obtained by the second cameral and compare a color of the tread portion color line to a reference color corresponding to a tire specification to determine the specification of the tire. In certain embodiments, in the tire inspection device in accordance with an exemplary embodiment of the present inventive concept, the second camera may be moveable in a vertical direction such that it can capture data regarding the tread portion color line of each of the tires stacked on the transfer conveyor in multistage.

The tire inspection device in accordance with an exemplary embodiment of the present inventive concept may further include a laser displacement sensor fixedly secured to the frame over the transfer conveyor for measuring a height of the tires stacked on the transfer conveyor in multistage. And, in the tire inspection device in accordance with an exemplary embodiment of the present inventive concept, the frame may have a mover mounted thereto for moving the second camera in the vertical direction.

And, in the tire inspection device in accordance with an exemplary embodiment of the present inventive concept, the mover may include a servo motor fixedly mounted to the frame, a lead screw arranged on the frame in an up/down direction connected to the servo motor, a guide rail mounted to the frame parallel to the lead screw, and a slider screw coupled to the lead screw to be slideable on the guide rail for fixedly securing the second camera thereto.

And, in the tire inspection device in accordance with an exemplary embodiment of the present inventive concept, the controller may control the mover according to the measured value of the laser displacement sensor

A method for inspection of a tire in accordance with an exemplary embodiment of the present inventive concept may include the steps of providing the tire inspection device for inspecting at least one tire being transferred from a tire sub-line to a tire mounting process along a transfer conveyor, capturing, with a first camera, data regarding a surface of the tire placed on the transfer conveyor, forwarding the data to a controller, analyzing the data, detecting a position of a balance marker on the surface of the tire and determining an orientation of the tire based on the detected position of the balance marker.

The method for inspection of a tire in accordance with an exemplary embodiment of the present inventive concept may further include the steps of measuring a height of the tire placed on the transfer conveyor with a laser displacement sensor, and forwarding a measured value thereof to the controller.

The method for inspection of a tire in accordance with an exemplary embodiment of the present inventive concept, may further includes the step of controlling a position of the second camera by controlling the mover with the controller according to the measured value measured by the laser displacement sensor.

And, the method for inspection of a tire in accordance with an exemplary embodiment of the present inventive concept may further include the steps of capturing, with a second camera, data regarding a tread portion color line of the tire placed on the transfer conveyor, and forwarding the data to the controller.

And, the method for inspection of a tire in accordance with an exemplary embodiment of the present inventive concept may further include the steps of analyzing the vision data captured by the second camera, and determining a specification of the tire based on the analysis of the data.

And, the method for inspection of a tire in accordance with an exemplary embodiment of the present inventive concept may further include the step of displaying a result of determination of the orientation of the tire.

And, the method for inspection of a tire in accordance with an exemplary embodiment of the present inventive concept may further include the step of comparing the tread portion color line to a reference color corresponding to a reference specification to determine the specification of the at least one tire, and displaying whether the color of the tread portion color line is the same as a reference color. The exemplary embodiments of the present inventive concept can inspect the orientation and the specification of the tire being transferred to the tire mounting process automatically, by recognizing the existence of the balance marker attached to a surface of the tire and the tread portion color line of the tire with the cameras.

Eventually, in an exemplary embodiment of the present inventive concept, since transfer of a tire different from the specification of the vehicle and a tire having an incorrect orientation can be prevented in advance, assembly of the wheel and the tire with mismatched specifications and wrong assembly of the tire can be prevented at the tire mounting process.

### BRIEF DESCRIPTION OF THE DRAWINGS

The attached drawings illustrate an exemplary embodiment of the present inventive concept, provided for describing the present inventive concept in more detail, but not for limiting technical aspects of the present inventive concept.

FIG. 1 illustrates a block diagram of a tire inspection device in accordance with an exemplary embodiment of the present inventive concept, schematically.

FIG. 2 illustrates a perspective view of an exemplary tire applied to a tire inspection device in accordance with an exemplary embodiment of the present inventive concept.

FIG. 3 illustrates a schematic view of a mover applied to a tire inspection device in accordance with an exemplary embodiment of the present inventive concept.

FIG. 4 illustrates a flow chart showing the steps of a method for inspection of a tire by using a tire inspection device in accordance with an exemplary embodiment of the present inventive concept.

### DETAILED DESCRIPTION OF THE EMBODIMENTS

The present inventive concept will be described more fully hereinafter with reference to the accompanying drawings, in which an exemplary embodiment of the inventive concept is shown. As those skilled in the art would realize, the described embodiment may be modified in various different ways, all without departing from the spirit or scope of the present inventive concept.

Parts not relevant to the present inventive concept will be omitted for describing the present inventive concept clearly, and throughout the specification, identical or similar parts will be given the same reference numbers.

And, since sizes and thicknesses of elements are shown at will for convenience of description, the present inventive concept is not limited to the drawings without fail, but the thicknesses may be exaggerated for expressing different parts and regions, clearly.

And, though terms including ordinal numbers, such as first or second, can be used for describing various elements in the Detailed Description of the present disclosure, the elements are not confined by the terms, and are used only for making one element distinctive from other elements.

Throughout the specification, unless explicitly described to the contrary, the word “comprise” and variations such as “comprises” or “comprising”, will be understood to imply the inclusion of stated elements but not the exclusion of any other elements.

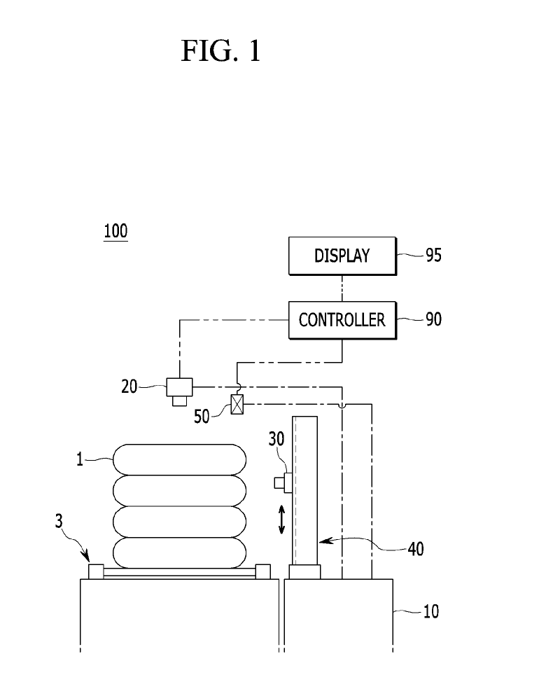

FIG. 1 illustrates a block diagram of a tire inspection device in accordance with an exemplary embodiment of the present inventive concept, schematically.

Referring to FIG. 1, the tire inspection device 100 may be applied to a tire sub-line which supplies the tire 1 to a tire mounting line in an outfitting line at which various outfitting components are mounted to a vehicle body.

At the tire sub-line, tire storage spaces may be designated for different specifications of vehicles, and four or five stacked tires 1 may be supplied to each of the designated storage spaces. The stacked tires 1 may then be transferred to a tire mounting process with a transfer conveyor 3. The tire inspection device 100 in accordance with an exemplary embodiment of the present inventive concept is for automatic inspection of a regular position and a specification of the tire on the transfer conveyor 3 before the tire is supplied to the tire mounting process from the tire sub-line.

However, it is required to understand that the scope of the present inventive concept is not limited to a process for assembly of the vehicle body always, but technical aspects of the present inventive concept may be applied as far as it is related to automatic inspection of the specification and so on at a tire manufacturing factory, a tire logistics factory, or so on.

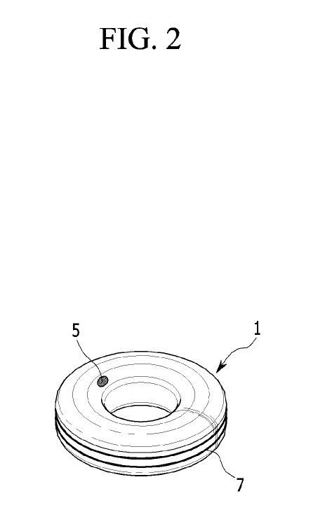

In the meantime, referring to FIG. 2, the tire 1 applicable to an exemplary embodiment of the present inventive concept is an asymmetric tire having an inside wall tread pattern and an outside wall tread pattern different from each other, wherein, for making the inside wall and the outside wall distinctive, a balance sticker 5 is attached to the outside wall. The balance sticker is not limited to a sticker. It may be any type of marker indicating the position of the tire. In another embodiment (not shown), the balance sticker may be attached to the inside wall of the tire. In other embodiments, the balance sticker may be placed on other surfaces of the tire, such as the curved surfaces on the interior and exterior of the tire, on a portion closer to the inside or outside wall.

And, the tire 1 has a standard of the tire marked at a tread portion thereof and a tread portion color line 7 for workers to make easy recognition of the standard of the tire.

The tire inspection device 100 in accordance with an exemplary embodiment of the present inventive concept has a structure which may make automatic inspection of the correct orientation and the specification of the tire 1 to be supplied to the tire mounting process by recognizing existence of the balance sticker 5 attached to a surface of the tire 1 and the tread portion color line 7.

For this, the tire inspection device 100 in accordance with an exemplary embodiment of the present inventive concept includes, as basic elements, a frame 10, a first camera 20, a second camera 30, and a controller 90.

The frame 10 for supporting various elements of the tire inspection device 100 in accordance with an exemplary embodiment of the present inventive concept may include one frame or two or more than two frames.

The frame 10 includes different supporting elements thereof, such as brackets, bars, rods, plates, housings, cases, blocks, partition walls, ribs, rails, and collars.

However, since the different supporting elements are for mounting elements to be described further hereafter, to the frame 10, in an exemplary embodiment of the present inventive concept, the supporting elements are called the frame 10 collectively except in certain cases.

The frame 10 may be mounted to an outside of the transfer conveyor 3 at the tire sub-line.

In an exemplary embodiment of the present inventive concept, the first camera 20 is photographs at least one tire 1 placed on the transfer conveyor 3.

The first camera 20 may be a vision camera, also known as a vision head or a vision sensor in the art, and may have a lighting unit (Not shown) for directing a light to a vision taking portion. In other embodiments, the camera 20 may be an infra-red sensor, a scanner, a laser sensor, or any other device that can obtain data regarding the presence and position of a balance sticker or marker. The data obtained may be vision data or it may be another type of data containing information about at least one characteristic of the balance sticker or marker, such as texture or luminescence.

The first camera 20 may be fixedly mounted to the frame 10 to be positioned over the transfer conveyor 3, i.e., over a tire transfer path. The first camera 20 may photograph a surface of the tires 1 and forward data thereof to the controller 90 to be described later further.

In this case, the tires 1 stacked on the transfer conveyor 3 in multistage may be transferred to the tire mounting process with a tire loading unit (Not shown).

Therefore, the first camera 20 may photograph a surface of the tires 1 before the tires 1 are transferred to the tire mounting process.

In an exemplary embodiment of the present inventive concept, the second camera 30 may be configured to capture data regarding the tread portion color line 7 described hereinabove.

The second camera 30 may photograph the tread portion color line 7 of each of the tires placed in single or multistage on the transfer conveyor 3 from a side of the transfer conveyor 3.

The second camera 30 may be a vision camera, also known in the art as a vision head or a vision sensor, and may have a lighting unit (Not shown) for directing a light to a vision taking portion. In an alternate embodiment, the camera 30 may be another device as is described hereinabove regarding the first camera 20.

The second camera 30 may be mounted to an outside of the transfer conveyor 3 to be movable in a vertical direction, i.e., may be mounted to the frame 10 to be movable in the vertical direction on an outside of the tire transfer path.

The second camera 30 may be configured to be movable in up/down directions on the outside of the tire transfer path to control up/down direction positions of the second camera 30 with reference to an entire height of the tires 1 in a case the tires 1 are stacked on the transfer conveyor 3 in multistage. However, the movement of the second camera 30 is not necessarily limited to the vertical direction. The second camera 30 may be moveable in any conceivable direction that will enable it to capture data regarding the tread portion color line 7 of the tire 1.

For this, the frame 10 has a mover 40 mounted thereto for making the second camera 30 to move in the up/down directions. The mover 40 may be a motor cylinder which can convert a torque of a motor to a linear movement. Alternatively, it may be another device capable of moving the second camera 30.

The second camera 30 may photograph the tread portion color line 7 of the tire while moving from a lower side to an upper side or from the upper side to the lower side for a predetermined distance with reference to the entire height of the tires 1 by the mover 40.

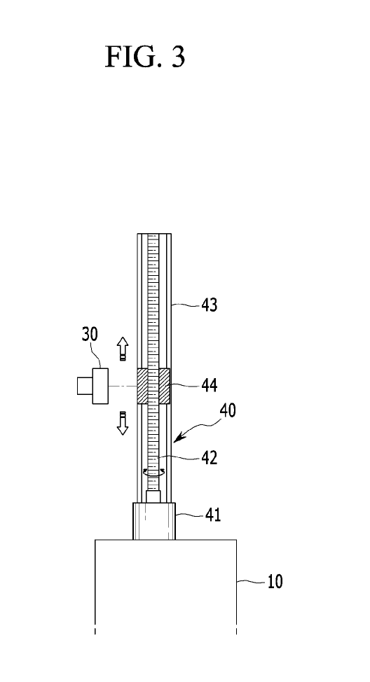

In above description, as shown in FIG. 3, the mover 40 may include a servo motor 41, a lead screw 42, a guide rail 43 and a slider 44.

In an exemplary embodiment, the servo motor 41 is mounted to the frame 10 fixedly secured thereto. The lead screw 42 is arranged on the frame 10 in an up/down direction connected to a drive shaft of the servo motor 41. The guide rail 43 is mounted to the frame 10 parallel to the lead screw 42. The slider 44 is screw coupled to the lead screw 42 to be slideable on the guide rail 43.

In this case, the lead screw 42 has one side end connected to the drive shaft of the motor 41 and the other side end rotatably supported on the guide rail 43. And, the slider 44 has the second camera 30 fixedly secured thereto.

According to this, if the servo motor 41 rotates in one or the other direction, the lead screw 42 also rotates in one or the other direction, for the slider 44 to move in up/down directions along the guide rail 43.

According to this, since the slider 44 moves in the up/down directions along the guide rail 43, the second camera 30 in accordance with an exemplary embodiment of the present inventive concept may move in the up/down directions together with the slider 44. In other embodiments, the mover 40 may move the second camera 30 via other means such as a conveyer belt or a motor-driven pulley.

In the meantime, as shown in FIG. 1, the tire inspection device 100 in accordance with an exemplary embodiment of the present inventive concept further includes a laser displacement sensor 50 for setting a reference of the entire height of the tires 1 placed on the transfer conveyor 3. The laser displacement sensor measures the height of the stack of tires.

In an exemplary embodiment of the present inventive concept, the laser displacement sensor 50 measures the height of the tires 1 stacked on the transfer conveyor 3 in multistage. The laser displacement sensor 50 is fixedly secured to the frame 10 over the transfer conveyor 3, i.e., over the transfer path of the tire 1. Alternatively, another height-measuring device such as a vision camera, infra-red sensor, or ultrasonic sensor may be used instead of the laser displacement sensor.

The laser displacement sensor 50 directs a laser beam to the tire 1 and receives the laser beam reflected at the tire for measuring the entire height of the tires 1 with reference to a base of the transfer conveyor 3 and forwards a value measured thus to the controller 90 to be described later further.

Since the laser displacement sensor 50 is a laser type displacement sensor known to persons in this field of art widely, more detailed description of the laser displacement sensor 50 will be omitted from the specification. In an exemplary embodiment of the present inventive concept, the controller 90 controls the general operation of the inspection device 100, such as obtaining the data from the first camera 20, analyzing the data to detect a balance marker or sticker on the surface of a tire, and determining an orientation of the tire 1 with based on the detected position of the balance marker or sticker 5 attached to the surface of the tire 1.

That is, the controller 90 processes the data obtained from the first camera 20 to determine that the tire 1 is being supplied while positioned in a correct orientation, if the balance sticker 5 is recognized in a reference position on a surface of the tire. In certain embodiments, the data obtained may be vision data, and an image corresponding to the balance sticker 5 may be processed based on the vision data.

In certain embodiments, the controller 90 may excerpt only the image of a balance sticker 5 portion by removing noise from the vision data obtained from the first camera 20 with a filter, and processing the image with Threshold and Blob.

In certain embodiments, the controller 90 may determine the specification of the tire 1 with the tread portion color line 7 by obtaining the vision data from the second camera 30 and analyzing the vision data.

In this case, the controller 90 may recognize the specification of the tire finally by removing the noise from the vision data obtained from the second camera 30 with the filter and separating the tread portion color line 7 from letters, not to recognize a letter portion, but to recognize only a color of a color line portion and a position thereof.

And, the controller 90 controls the mover 40 described above according to a height measured value of the tires 1 received from the laser displacement sensor 50 for controlling the vertical movement of the second camera 30.

Moreover, the controller 90 may display a result of the orientation determined by existence of the balance sticker 5 on the display 95. It may also display whether or not the color the tread portion color line 7 is the same a reference color of a specification on the display 95.

In the meantime, in an exemplary embodiment of the present inventive concept, the second camera 30 may move upward as much as the entire height of the tires 1 measured by the laser displacement sensor 50, may photograph the tread portion color line 7 of an uppermost tire 1, may move a predetermined distance downward, and may photograph the tread portion color line 7 of a next tire 1, in succession.

Alternatively, the second camera 30 may photograph the tread portion color line 7 from a base side of the transfer conveyor 3 with reference to the entire height of the tires 1 measured by the laser displacement sensor 50, may move upward by a predetermined distance and may photograph the tread portion color line 7 of a next tire 1, in succession.

Furthermore, the second camera 30 may move upward as much as the entire height of the tires 1 measured by the laser displacement sensor 50, may photograph the tread portion color line 7 of the uppermost tire 1, may move downward as much as a height of a next tire 1 measured by the laser displacement sensor 50 in a state the uppermost tire 1 is transferred by the tire loading unit, and may photograph the tread portion color line 7 of a next tire 1, in succession.

A method for inspection of a tire by using the tire inspection device 100 in accordance with an exemplary embodiment of the present inventive concept will be described with reference to the drawings disclosed before and the attached drawings, in detail.

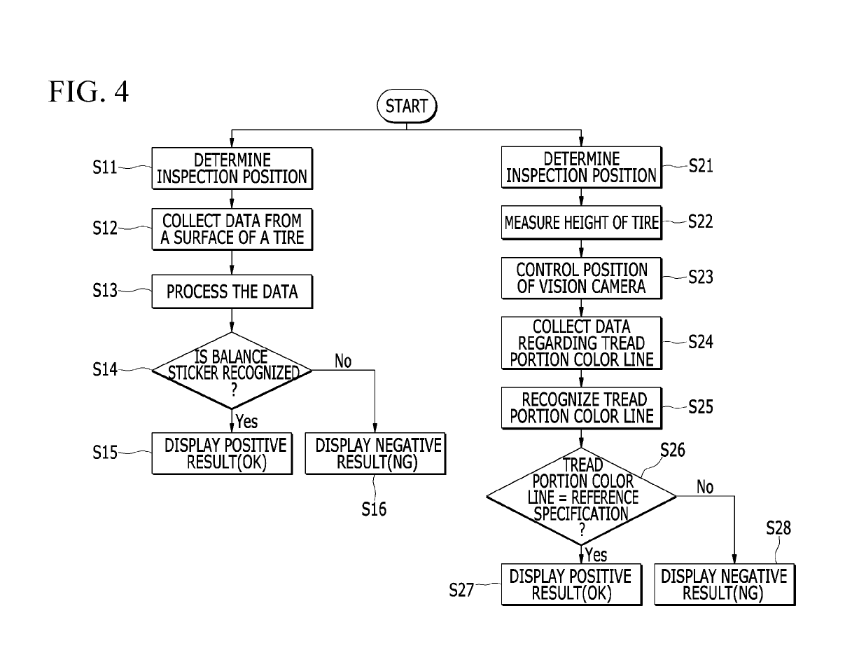

FIG. 4 illustrates a flow chart showing the steps of a method for inspection of a tire by using a tire inspection device in accordance with an exemplary embodiment of the present inventive concept.

Referring to the drawings disclosed before and FIG. 4, in an exemplary embodiment of the present inventive concept, the tires 1 stored in the storage spaces of different vehicle specifications are transferred along the transfer conveyor 3 in a state the tires are stacked in a vertical direction.

In this process, if the tires 1 are positioned at a determined inspection position, i.e., on a side of a frame 10 (S11 step), in an exemplary embodiment of the present inventive concept, data regarding a surface of the uppermost tire is collected by the first camera 20 from over the transfer conveyor 3, and the data is forwarded to the controller 90 (S12 step).

Then, the controller 90 analyzes the vision data obtained from the first camera 20, and determines a regular position of the tire 1 from existence of a balance sticker 5 attached to the outside wall of the tire 1.

In detail, the controller 90 removes noise from the vision data obtained from the first camera 20 with a filter, and process the vision data into an image with Threshold and Blob (S13 step).

Then, the controller 90 excerpts an image of a balance sticker 5 portion. If it recognizes the image of the balance sticker 5 (S14 step), it determines that the tire 1 is being supplied in a correct orientation and displays a positive result (OK) of the determination on a display 95 (S15 Step).

If the controller 90 fails to recognize the balance sticker 5 from the data obtained from the first camera 20 (S14 step), and, determining that tire 1 is being supplied in an incorrect orientation, displays a negative result (NG) of the determination on the display 95 (S16 step).

The above-described process for determining the orientation of a tire 1 based on the detection of a balance sticker 5 on a surface of the tire 1 with the first camera 20 is carried out before the tires 1 are transferred to the tire mounting process with the tire loading unit.

During the above-described process, in an exemplary embodiment of the present inventive concept, if the tires 1 are positioned at a predetermined inspection position (S21 step), the entire height of the tires 1 is measured with a laser displacement sensor 50 and a measured value thereof is forwarded to the controller 90 (S22 step).

Then, the controller 90 controls the mover 40 according to a height measured value received from the laser displacement sensor 50 to move the second camera 30 upward (S23 step).

Then, in an exemplary embodiment of the present inventive concept, data regarding the tread portion color line 7 of the uppermost tire 1 is captured by the second camera 30 (S24 step), the second camera 30 is moved downward by a predetermined distance by the mover 40 (S23 step), data regarding the tread portion color line 7 of a next tire 1 is captured by the second camera 30 (S24 step), and the data is forwarded to the controller 90, in succession.

Eventually, the controller 90 may obtain the data from the second camera 30, may analyze the data, and may determine the specification of the tire 1 from the color of the tread portion color line 7.

In detail, the controller 90 removes the noise from the vision data obtained from the second camera 30 with the filter, separates the tread portion color line 7 and the letters, not to recognize the letter portion, but to recognize only the color and the position of the color line portion (S25 step).

Then, the controller 90 compares the color and the position of the tread portion color line 7 to a preset tire specification, and, if the color and the position of the tread portion color line 7 are determined to be the same with the preset tire specification (S26 step), the controller 90 displays the result (OK) on the display 95 (S27 step).

If it is determined that the color and the position of the tread portion color line 7 are not the same with the preset tire specification (S26 step), the controller 90 displays the result (NG) on the display 95 (S28 step).

In the meantime, in an exemplary embodiment of the present inventive concept, data regarding the tread portion color line 7 of the lowermost tire 1 may be captured by the second camera 30 from a base side of the transfer conveyor 3 with reference to the entire height of the tires 1 measured by the laser displacement sensor 50.

Then, in an exemplary embodiment of the present inventive concept, the second camera 30 is moved upward by a predetermined distance with the mover 40 (S23 step), data regarding the tread portion color line 7 of a next tire 1 may also captured by the second camera 30, in succession (S24 step).

Or, alternatively, in an exemplary embodiment of the present inventive concept, the second camera 30 may be moved upward as much as the entire height of the tires 1 measured by the laser displacement sensor 50 with the mover 40 (S23 step), for the second camera 30 to photograph the tread portion color line 7 of the uppermost tire 1 (S24 step).

Then, in an exemplary embodiment of the present inventive concept, in a state the uppermost tire 1 is transferred by the tire transfer unit, the second camera 30 may be moved downward as much as the height of a next tire 1 measured by the laser displacement sensor 50 with the mover 40 (S23 step), for the second camera 30 to photograph the tread portion color line 7 of the next tire, in succession (S24 step).

According to the method for inspection of a tire in accordance with an exemplary embodiment of the present inventive concept described hereinabove, by recognizing the existence of the balance sticker 5 attached to a surface of the tire 1 and the tread portion color line 7 of the tire 1 with the cameras, the orientation and the specification of the tire 1 being transferred to the tire mounting process can be inspected automatically.

In an exemplary embodiment of the present inventive concept, since transfer of a tire different from the specification of the vehicle and a tire having an incorrect orientation to the tire mounting process can be prevented in advance, assembly of the wheel and the tire with mismatched specifications and wrong assembly of the tire can be prevented at the tire mounting process.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A tire inspection device for inspecting at least one tire being transferred from a tire sub-line to a tire mounting process along a transfer conveyor, comprising:
a frame mounted to an outside of the transfer conveyor;
a first camera fixedly secured to the frame over the transfer conveyor configured to capture data from a surface of the at least one tire placed on the transfer conveyor; and
a controller configured to analyze a vision data captured by the first camera, detect a position of a balance marker on the surface of the at least one tire, and determine an orientation of the at least one tire based on the detected position of the balance marker.

2. The device of claim 1, wherein
the controller is further configured to determine that the at least one tire is in a correct orientation if, upon processing the data obtained from the first camera, the balance marker is recognized.

3. The device of claim 1, further comprising
a second camera mounted to the frame on an outside of the transfer conveyor, the second camera configured to be movable to capture data regarding a tread portion color line.

4. The device of claim 3, wherein
the controller is configured to analyze the vision data obtained by the second camera and compare a color of the tread portion color line to a reference color corresponding to a tire specification to determine the specification of the tire.

5. The device of claim 3, wherein the second camera is configured to be moveable in a vertical direction such that it can capture data regarding the tread portion color line of each at least one tire in a stack of tires on the transfer conveyor in multistage.

6. The device of claim 3, further comprising
a laser displacement sensor fixedly secured to the frame over the transfer conveyor, the laser displacement sensor configured to measure a height of the stack of tires on the transfer conveyor in multistage.

7. The device of claim 6, wherein
the frame has a mover mounted thereto for moving the second camera in a vertical direction.

8. The device of claim 7, wherein
the mover includes;
a servo motor fixedly mounted to the frame,
a lead screw arranged on the frame in an vertical direction connected to the servo motor,
a guide rail mounted to the frame parallel to the lead screw, and
a slider screw coupled to the lead screw to be slideable on the guide rail for fixedly securing the second camera thereto.

9. The device of claim 7, wherein
the controller is configured to control the mover according to the measured value of the laser displacement sensor.

10. A method for inspection of a tire comprising the steps of:
providing a tire inspection device for inspecting at least one tire being transferred from a tire sub-line to a tire mounting process along a transfer conveyor;
capturing, with a first camera, data regarding a surface of the at least one tire placed on the transfer conveyor, and forwarding a vision data to a controller;
analyzing the vision data;
detecting a position of a balance marker on the surface of the at least one tire; and
determining an orientation of the tire based on the detected position of the balance marker.

11. The method of claim 10, further comprising the steps of:
measuring a height of the tire placed on the transfer conveyor by a laser displacement sensor; and
forwarding a measured value to a controller.

12. The method of claim 11, further comprising the step of
controlling a position of the second camera by controlling a mover according to the measured value measured by the laser displacement sensor.

13. The method of claim 12, further comprising the steps of:
capturing, with a second camera, data regarding a tread portion color line of the at least one tire placed on the transfer conveyor; and
forwarding the data to the controller.

14. The method of claim 13, further comprising the steps of:
analyzing the data; and
determining a specification of the at least one tire based on the analysis of the data.

15. The method of claim 10, further comprising the step of
displaying the orientation of the at least one tire.

16. The method of claim 14, further comprising the steps of
comparing the tread portion color line to a reference color corresponding to a reference specification to determine the specification of the at least one tire, and displaying whether the color of the tread portion color line is substantially the same as the reference color.

17. The device of claim 1, wherein the surface is an outside wall of the tire.

18. The device of claim 1, wherein the balance marker is a sticker.
